(19) United States
(12) Patent Application Publication
(10) Pub. No.: US 2005/0048835 A1
(43) Pub. Date: Mar. 3, 2005

(54) Coaxial cable splitter connector

(76) Inventor: Darren Clark, Mt. Sinai, NY (US)

Correspondence Address: WILLIAM COLLARD;COLLARD & ROE, P.C., 1077 NORTHERN BOULEVARD, ROSLYN, NY, 11576, US

(21) Appl. No.: 10/648,880

(22) Filed: Aug. 27, 2003

(51) Int. Cl. H01R 9/05

(52) U.S. Cl. 439/579

(57) ABSTRACT

A coaxial cable connection for connecting two cables into one connection which can be connected into a single signal cable. This connection can include a covering clamp for fitting over the two connecting cables. There can also be a sheath covering and clamping the two cables together adjacent to the covering clamp. There can also be a substantially tubular connector for connecting over the covering clamp and adjacent to the sheath. This covering clamp, the sheath, and the substantially tubular connector form a two-to-one cable connection so that a single cable carrying a signal can be connected to the substantially tubular connector and convey a signal into the two cables via the covering clamp. The process for creating this connection does not include any steps of welding, soldering, or gluing the clamp, the two coaxial cables, the tubular connector or the sheath together.

### BACKGROUND OF THE INVENTION

The present invention relates to a coupling device and a method for coupling two coaxial cables into one connection so that signals from a single coaxial cable can be easily transferred from one original cable into two different coaxial cables.

Coaxial cables can be used extensively in electrical or electronic industries wherein these coaxial cables can comprise an inner conductor, a dielectric or shield surrounding the inner conductor and an external concentric conductor surrounding the inner conductor. This external conductor can be in the form of a braided mesh wire. This external conductor can have a shield or a sheath covering this conductor.

Connectors for coaxial cables are known in the art. For example the following U.S. patents relate to connectors for coaxial cables: U.S. Pat. Nos. 3,151,211; 4,822,956; 4,678,865; 2,225,728; 5,088,936; 2,929,862; 2,889,394 and 6,530,808 all incorporated herein by reference.

### SUMMARY OF THE INVENTION

A coaxial cable connection for connecting two cables into one connection which can be connected into a single signal cable. This connection can include a covering clamp for fitting over the two connecting cables which can be in the form of a male or a female connector. There can also be a sheath covering and clamping the two cables together adjacent to the substantially u-shaped flat, split or crimped covering clamp which can be in the form of a male or female connector. There can also be a substantially tubular connector for connecting over the covering clamp and adjacent to the sheath. This covering clamp, the sheath, and the substantially tubular connector form a two-to-one cable connection so that a single cable carrying a signal can be connected to the substantially tubular connector and convey a signal into the two cables via the covering clamp. The process for creating this connection does not include any steps of welding, soldering, or gluing the clamp, the two coaxial cables, the tubular connector or the sheath together. In addition to crimp the elements together there is no need for any special crimping terminals.

This type connection can be used to split a signal coming from a single signal carrying cable using as one example, the method described below.

The method for splitting a coaxial cable signal from a single signal carrying coaxial cable into two different coaxial cables comprises first the step of coupling two coaxial cables together. This step includes forming exposed leads on two separate coaxial cables; applying a clamp over the two exposed leads of the two cables; clamping the clamp onto the two exposed leads of the two cables such that the clamp is in direct electrical and signal connection with the two exposed leads; applying a sheath over the clamp to cover the two cables adjacent to the clamp and clamping the sheath onto the two cables to prevent the two cables from separating from the clamp; sliding the substantially tubular connector over the clamp to cover the clamp adjacent to the sheath; and coupling the substantially tubular connector to the two cables and to the sheath to secure the substantially tubular connector to the two cables to form a single coaxial cable connection. Next, a single coaxial cable carrying a signal is coupled to the single connection of the two coaxial cables to split the signal from the single coaxial cable and send it into the two coaxial cables.

As stated above this method does not include any steps of welding, soldering, or gluing the clamp, the two coaxial cables, the tubular connector or the sheath together.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 shows a side view of two coaxial cables connected to the cable connection;

FIG. 2 shows the tubular cover sliding over the two coaxial cables covered by a sheath;

FIG. 3a shows a single coaxial cable having a connection;

FIG. 3b shows the two coaxial cables with the sheath of FIGS. 1 and 2 inserted therein and also having a clamp applied to the two ends of the two coaxial cables;

FIG. 4a shows a clamp for clamping exposed leads for two coaxial cables together;

FIG. 4b shows the sheath for coupling the two coaxial cables together;

FIG. 4c shows the tubular connector for coupling to the two coaxial cables as shown in FIG. 1; and

FIG. 5 shows the coupling connection coupled together; and

FIG. 6 shows the process for applying the coupling connection to the two coaxial cables.

### DETAILED DESCRIPTION OF PREFERRED EMBODIMENTS

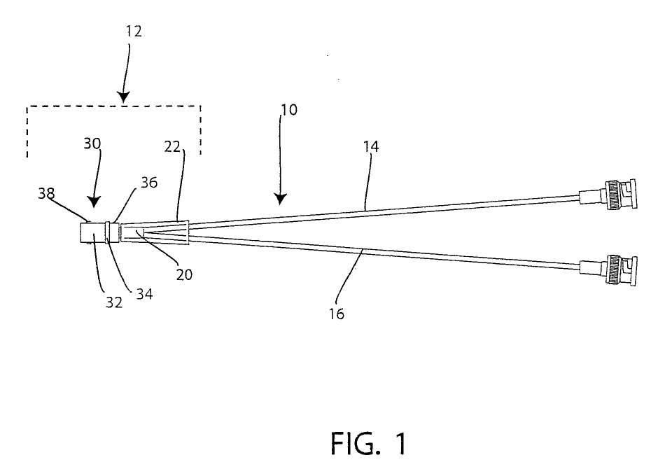

Turning now in detail to the drawings, FIG. 1 shows a side view of a device 10 which includes two coaxial cables 14 and 16 connected to the cable connection 12. This cable connection includes a sheath 20, a covering sheath 22 and a coupler, or connection element 30 in the form of a tubular or substantially cylindrical connector having a first coupling section 32, a rim 34 and a back coupling section 36. Connection element 30 can be tubular or in the form of a cylinder. Connection element 30 also contains protrusions 38 which can be used to couple to adjacent connection elements.

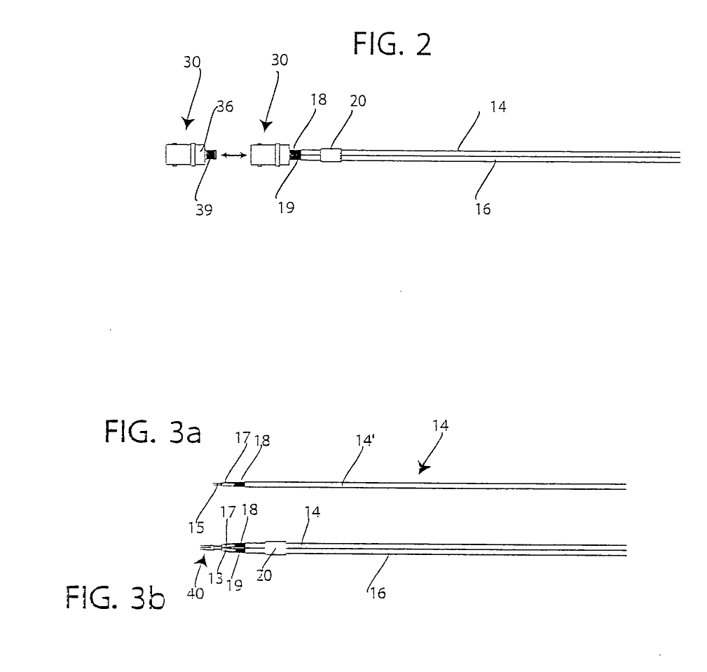

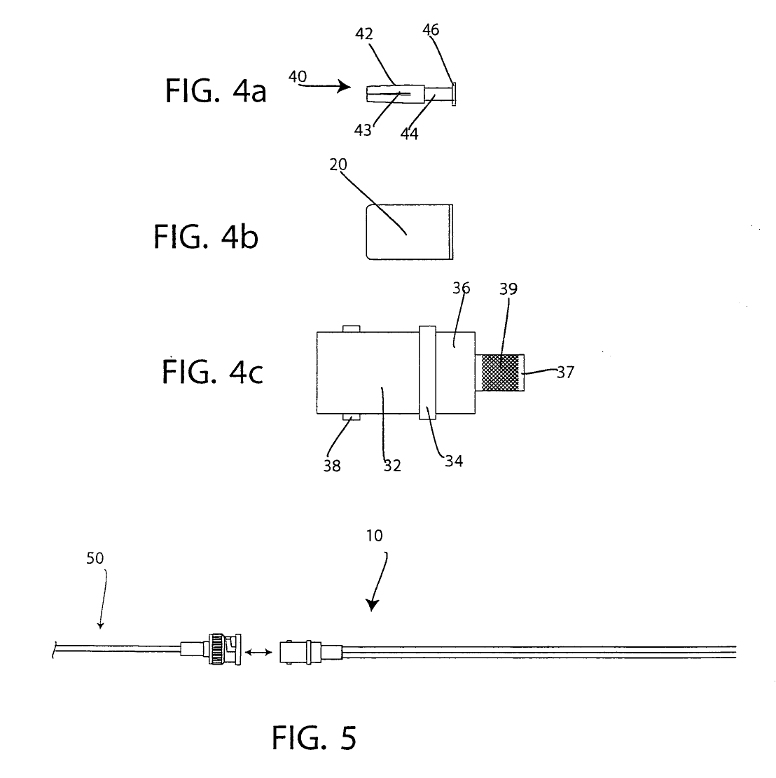

FIG. 2 shows the tubular connector or coupling element 30 sliding over the two coaxial cables 14 and 16 covered and clamped together by sheath 20. In this view, first coaxial cable 14 has an exposed section containing a shielding segment 18 wherein this shielding is used to keep other interfering signals out while still allowing a return path of signals back from the original sent signal on a conductor shown in FIG. 3A. Tubular connector 30 is explained in greater detail in FIG. 4C but can contain a connecting region 36 and a shielded connecting region 39 for connecting to braided sections 18 and 19 of cables 14 and 16 respectively.

FIG. 3a shows a single coaxial cable 14 having a stripped end forming a connection so that there is an open conducting end 15 an intermediate section 17 a shielded section 18 and a final covering 14′ which all form coaxial cable 14.

FIG. 3b shows the two coaxial cables with sheath 20 of FIGS. 1 and 2 inserted thereon to hold cables 14 and 16 together and also having a clamp or connection end 40 applied to the two ends of the two coaxial cables 14 and 16. Clamp 40 clamps conducting ends of cables 14 and 16 together so that these two ends are positioned adjacent to each other. Clamp 40 is made from a malleable material such as a metal in the form of copper so that clamp 40 can be clamped down on these conducting ends. With this design, a signal from an individual cable can be transferred to the two different cables 14 and 16. In addition shielded portions 18 and 19 are still exposed so that connection element 30 can be slid over and coupled to the two cables 14 and 16.

FIGS. 4a, 4b and 4c show the different components that comprise the cable connection. First as shown in FIG. 4a there is clamp 40 which includes a clamping end 42, which can have a crimp in a flat section, a slit 43 or a u-shape, an intermediate clamping region 44 which can be pressed or crimped onto exposed ends of wires 14 and 16 and a flange 46 defining an open receiving region. Clamp 40 is for clamping exposed leads for the two coaxial cables 14 and 16 together. Essentially clamp 40 is pressed onto these exposed leads which are shown by way of example in FIG. 3A as conducting end 15. Next, clamp 40 is pressed on to form an end conductor a male conductor or a female connection end for receiving or conveying a signal. Next, sheath, holding element, or covering 20, which can be in the form of a cylinder, as shown in FIG. 4B is placed onto the two cables 14 and 16 to keep them from splitting apart in a region near the connection with clamp 40.

FIG. 4c shows the tubular connector 30 for providing the final coupling for the two coaxial cables 14 and 16 as shown in FIG. 1. Tubular connector 30 fits over clamp 40 and provides the coupling connection necessary to couple to a single signal carrying cable 50 as shown in FIG. 5. Tubular connector 30 contains a first coupling cylindrically shaped region 32, a second flanged region 34 which forms a cylindrical bow out from first coupling region 32, with flanged region 34 for receiving, but stopping a connector from a connecting cable such as single signal carrying cable 50 (FIG. 5). Adjacent to flanged region 34 is a coupling region 36 which is also cylindrically shaped, and is used to guide clamp 40 inside and there-through. Adjacent to coupling region 36 is an extended cylindrical region 37 which has a smaller diameter than cylindrical region 36 and which is for supporting a shielded connection 39 which forms an electrical connection with shielded sections 18 and 19 on cables 14 and 16 respectively.

Finally, FIG. 5 shows the coupling connection coupled together.

In use, the double cable connection 12 allows a single signal carrying cable 50 to convey a signal from a single cable and split this signal into two redundant signals so that cable connections attached at ends of these two cables 14 and 16 can be connected into two different redundant systems. This splitter provides a simplified and improved system for splitting a coaxial cable because previous designs would require soldering, welding, gluing or other more complicated procedures that require additional time and expense to assemble. In addition the design of the above embodiment(s) is an improvement because it provides a coaxial cable signal splitter that allows two cables to join one cable in a substantially coaxial manner or essentially along the same axis to allow for greater room for applying these connections.

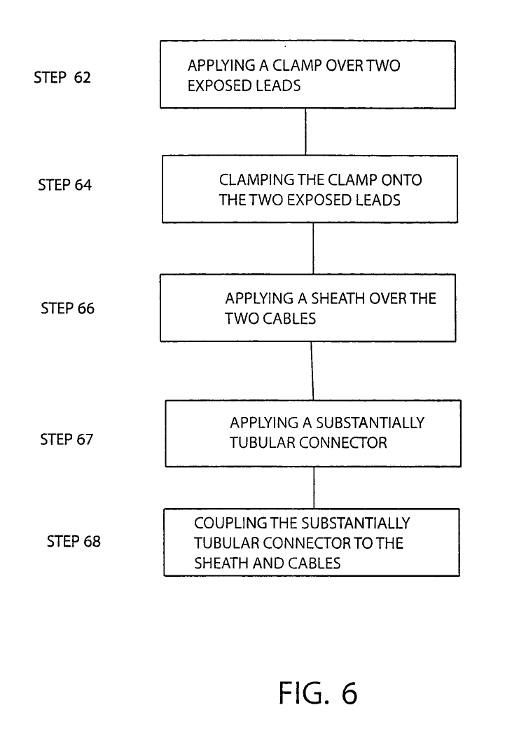

The process for applying the coupling connection is shown in FIG. 6. This process includes steps 62-68. For example, step 62 includes applying clamp 40 over the two leads. Step 64 includes clamping clamp 40 over the two exposed leads. Step 66 includes applying a sheath over the two cables 14 and 16. Step 67 includes applying tubular connector 30 onto the connection end, while step 68 includes clamping tubular connector 30 onto clamp 40 and also onto cables 14 and 16.

In one example or embodiment, clamp 40 can be a female contact for a 26 AWG wire (or RG 58) wherein clamp 40 can receive one 20 gauge wire or two 30 gauge (RG 179) wires such as in the two coaxial cables 14 and 16. Sheath 20 can be a ferrule or crimp ring which is standard for a cable with a nominal outside diameter of 0.193 inches. Tubular connector 30 can be a standard BNC connector for a cable with a nominal outside diameter of 0.193 inches. With this type design, the process is as follows:

Cables 14 and 16 are stripped so that conducting ends 15 on cable 14 and another conducting end (not shown on cable 16 are exposed. In addition a braided or shielding section 18 on cable 14 and 19 on cable 16 is exposed as well. The next two steps can occur in alternate order. One of the steps includes sliding sheath 20 over cables 14 and 16 past the braided or shielding sections 18 and 19. The other step includes clamping clamp 40 in clamping region 44 onto the two exposed ends of the inner conductors of cables 14 and 16. Next, tubular conductor 30 is slid on so that shielded connecting region 39 contacts braids 18 and 19 of cables 14 and 16 and slides under these braids 18 and 19 which can be made of a conducting metal such as thin copper wire. Next, sheath 20 is slid back over on top of this region of connection 39 and then crimped on over connecting region 39 creating a physical and electrical connection between connecting region 39 and braids or braided regions 18 and 19. At this point, the connection end is complete and can provide many benefits. First, each cable such as in cables 14 and 16 remains substantially parallel to each other so that it forms a compact connection. Next this connection is in a solderless environment so that it will not affect the conducting performance of the connection. Soldered connections can be affected by temperature, moisture, and humidity.

Because this connection uses known components in a new way, custom molding of this connection is not necessary. In testing, this double crimp far exceeds a 201b tensile or pull test. Finally, because the termination is within the connector, db loss is at a minimum and the cable will maintain an approximately 100% shielding. While one example was shown above the concepts disclosed above could be used for cables and connectors of different sizes.

Accordingly, while at least one embodiment of the present invention have been shown and described, it is to be understood that many changes and modifications may be made thereunto without departing from the spirit and scope of the invention as defined in the appended claims.

1. A coaxial cable connection for connecting two cables into one connection which can be connected into a signal cable, the connection comprising:
a) a covering clamp for fitting over the two connecting cables;
b) a sheath covering and clamping the two cables together adjacent to said covering clamp; and
c) a substantially tubular connector for connecting over said covering clamp and adjacent to said sheath wherein said covering clamp, said sheath, and said substantially tubular connector form a two-to-one cable connection so that a single cable carrying a signal can be connected to the substantially tubular connector and convey a signal into the two cables via said covering clamp.

2. The connector as in claim 1, wherein said clamp is made from a malleable material so that it can clamp around an exposed connection area of the two cables.

3. The connector as in claim 1, wherein said clamp is formed as a female connector.

4. The connector as in claim 3, wherein said clamp is formed as a female connector for receiving either one RG 58 cable or at least two RG 179 cables.

5. A method for creating a connection between a single signal carrying cable and two cables for carrying and splitting that same signal comprising the following steps:
a) applying a clamp over two exposed leads of the two cables;
b) clamping the clamp onto the two exposed leads of the two cables such that said clamp is in direct electrical and signal connection with the two exposed leads;
c) applying a sheath over said clamp to cover the two cables and clamping said sheath onto said two cables to prevent said two cables from separating from said clamp;
d) sliding said substantially tubular connector over said clamp to cover said clamp; and
e) coupling said substantially tubular connector to the two cables and to said sheath to secure said substantially tubular connector to the two cables.

6. The method as in claim 5, wherein said step of coupling said substantially tubular connector to the two cables includes clamping said substantially tubular connector on to the two cables.

7. The method as in claim 5, further comprising the following step:
applying an additional sheath onto the two cables to cover said sheath and the two cables, wherein said additional sheath is coupled to said previously applied sheath.

8. A method for splitting a coaxial cable signal comprising the following steps:
a) sending a signal down a first coaxial cable;
b) coupling two coaxial cables together using the following steps:
i) forming exposed leads on two separate coaxial cables;
ii) applying a clamp over the two exposed leads of the two cables;
iii) clamping the clamp onto the two exposed leads of the two cables such that said clamp is in direct electrical, and signal connection with the two exposed leads;
iv) applying a sheath over said clamp to cover the two cables adjacent to said clamp and clamping said sheath onto said two cables to prevent said two cables from separating from said clamp;
v) sliding said substantially tubular connector over said clamp to cover said clamp adjacent to said sheath; and
vi) coupling said substantially tubular connector to the two cables and to said sheath to secure said substantially tubular connector to the two cables to form a single coaxial cable connection; and
c) coupling the single coaxial cable which carries the signal to the single coaxial cable connection of the two coaxial cables to split the signal from the single coaxial cable and send it into the two coaxial cables.

9. The method as in claim 8, wherein this method does not include any steps of welding, soldering, or gluing said clamp, the two coaxial cables, said tubular connector or said sheath together.
